(19) United States
(12) Patent Application Publication
(10) Pub. No.: US 2007/0266746 A1
(43) Pub. Date: Nov. 22, 2007

(54) Side Release Strap Lock wit han Indicator

(76) Inventor: CHUN TE YU, Fusing Township (TW)

Correspondence Address: HDSL, 4331 STEVENS BATTLE LANE, FAIRFAX, VA, 22033, US

(21) Appl. No.: 11/829,964

(22) Filed: Jul. 30, 2007

Related U.S. Application Data
(63) Continuation-in-part of application No. 11/437,691, filed on May 22, 2006.
(63) Continuation-in-part of application No. 11/474,936, filed on Jun. 27, 2006.
(63) Continuation-in-part of application No. 11/603,029, filed on Nov. 22, 2006.
(63) Continuation-in-part of application No. 11/785,440, filed on Apr. 18, 2007.

(30) Foreign Application Priority Data
Jul. 10, 2007 (TW) 096125144
Aug. 24, 2006 (TW) 095131202
Dec. 26, 2006 (TW) 095149064

(51) Int. Cl. E05B 65/52

(52) U.S. Cl. 70/69

(57) ABSTRACT

A strap lock includes a buckle lock and a strap. The buckle lock includes a male fastener, a female fastener, a key locking mechanism and an indicator. The male fastener is connected to one end of the strap. The female fastener is connected to the other end of the strap and detachably connected to the male fastener. The key locking mechanism is disposed on the female fastener and includes a core shaft having a key hole which is capable of receiving either one of a first key and a second key; the core shaft can be driven by either one of the first key and the second key to lock or release the male fastener from the female fastener. The indicator is movably disposed on the female fastener. In particular, the indicator moves to a displaying position when the key hole of the core shaft is inserted by the first key. Besides, the indicator can be restored to its original position via the second key.

### CROSS REFERENCE TO RELATED APPLICATION

This is a continuation-in-part of application Ser. No. 11/437,691, filed on May 22, 2006; a continuation-in-part of application Ser. No. 11/474,936 filed on Jun. 27, 2006; a continuation-in-part of application Ser. No. 11/603,029, filed on Nov. 22, 2006; and also a continuation-in-part of application Ser. No. 11/785,440, filed on Apr. 18, 2007.

### BACKGROUND OF INVENTION

1. Field of Invention

The present invention relates to a strap lock and in particular to a side release strap lock with an indicator wherein the strap lock can be locked or unlocked by either a first key or a second key.

2. Related Prior Art

U.S. Patent Application No. 2006/0266084 discloses a travel padlock which includes an indicator and a key lock having a key hole. When the key hole is inserted by a key or an object, the indicator moves to a displaying position, notifying a user that the padlock has been operated and his luggage is better to be checked immediately. Nevertheless, the padlock is a kind of lock much different from a strap lock, such as a side release buckle lock.

In addition, U.S. Patent Application No. 2007/0084256 discloses a strap lock with an indicator. The strap lock can be locked or unlocked by either one of a key locking mechanism and a combination locking mechanism. The key locking mechanism includes a core shaft having a key hole which can be inserted by a key. However, the indicator moves to a displaying position only when the key is inserted into the key hole and is rotated to drive the core shaft to rotate. Furthermore, the strap lock defines no opening for being inserted by an insert to enable the indicator to move back to its original position.

### SUMMARY OF INVENTION

One aspect of the invention provides a side release buckle lock with an indicator. In particular, the indicator moves to a displaying position upon insertion of a key or an object longitudinally into a key hole of the buckle lock.

Another aspect of the invention provides a strap lock with an indicator. A core shaft of the strap lock can be driven by two kinds of keys. In particular, one of the keys is used to drive the indicator to move to a displaying position; and the other one is used to restore the indicator back to its original position.

According to the present invention, a strap lock comprises a buckle lock and a strap. The buckle lock includes a male fastener, a female fastener, a key locking mechanism and an indicator. The male fastener is connected to one end of the strap. The female fastener is connected to the other end of the strap and detachably connected to the male fastener. The key locking mechanism is disposed on the female fastener and includes a core shaft having a key hole which is capable of receiving either one of a first key and a second key; the core shaft can be driven by either one of the first key and the second key to lock or release the male fastener from the female fastener. The indicator is movably disposed on the female fastener. In particular, the indicator moves to a displaying position when the key hole of the core shaft is inserted by the first key. Besides, the indicator can be restored to its original position via the second key.

Preferably, the key locking mechanism includes a cylinder. The core shaft is rotatably disposed in the cylinder. The key hole includes a first slot, a second slot and a third slot. The first and the second slots are in communication with each other to receive the first key. The first and the third slots are in communication with each other to receive the second key. Thus, the core shaft can be driven by either one of the first key and the second key.

Preferably, the indicator has a first ramp and a second ramp both facing the key hole. When the first key is inserted into the key hole, the first key pushes the first ramp to move the indicator to the displaying position. Contrarily, the second key can be inserted into the key hole to push the second ramp so as to move the indicator back to the original position.

Further benefits and advantages of the present invention will become clear as the description proceeds.

### BRIEF DESCRIPTION OF DRAWINGS

The invention will now be elucidated with reference to the following description and accompanying drawings where:

FIG. 1 is an exploded view of a strap lock according to the preferred embodiment of the present invention;

FIG. 2 is a cross-sectional view of the strap lock of FIG. 1;

FIG. 3 is a side view showing that the strap lock is operated by a first key;

FIG. 4 is a side view showing that the strap lock is operated by a second key;

FIG. 5 shows that the strap lock is in a locking status;

FIG. 6 is a top view showing that the strap lock is operated by the first key;

FIG. 7 shows that the strap lock includes a key locking mechanism with its core shaft being driven by the first key;

FIG. 8 shows that the strap lock includes an operating member being pushed forward;

FIG. 9 shows that the strap lock includes a male fastener being side-pressed to be released from the female fastener;

FIG. 10 is a top view showing that the strap lock is operated by the second key;

FIG. 11 shows that the core shaft is driven by the second key;

FIG. 12 shows that the operating member is pushed forward; and

FIG. 13 shows that the male fastener is side-pressed to be released from the female fastener.

### DETAILED DESCRIPTION OF PREFERRED EMBODIMENT

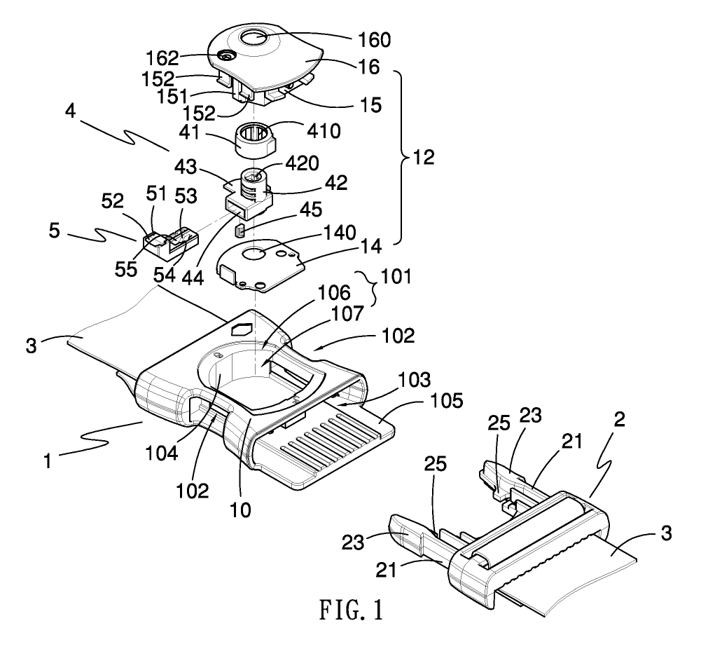

With reference to FIGS. 1 to 13, description will be given of a side release strap lock according to the preferred embodiment of this invention. The strap lock comprises a buckle lock and a strap 3. The buckle lock includes a female fastener 1, a male fastener 2, a key locking mechanism 4 and an indicator 5.

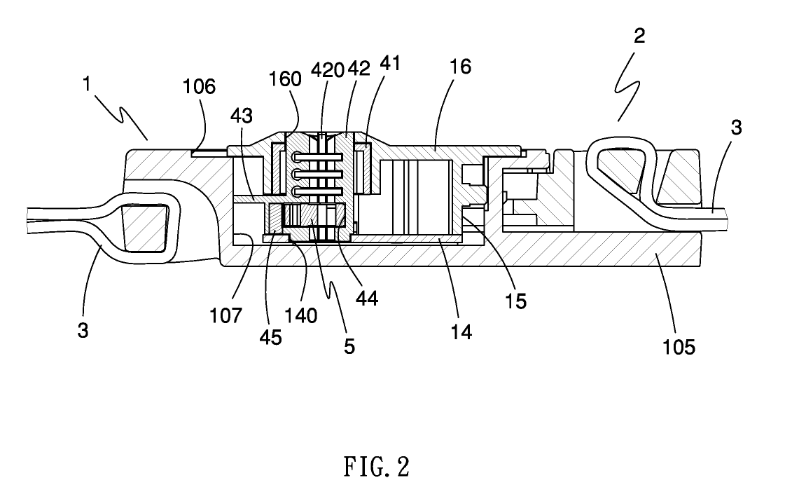

Referring first to FIGS. 1 and 2, the male fastener 2 is connected to one end of the strap 3 and includes two elastic arms 21 each having an outward protrusion 23 and an inward protrusion 25 opposed to the outward protrusion 23. The female fastener 1 is connected to the other end of the strap 3 and detachably connected with the male fastener 2. The female fastener 1 includes a body 10 and an operating member 12. The body 10 defines a main room 101, an insertion opening 103, and two side openings 102. The insertion opening 103 and the two side openings 102 are all in communication with the main room 101. The main room 101 is disposed in the center of the body 10 and includes a wide upper room 106 and a deep lower room 107. The insertion opening 103 is defined in a front of the body 10 for being inserted by the two elastic arms 21 of the male fastener 2. When the two elastic arms 21 are inserted into the insertion opening 103, the two side openings 102 receive the outward protrusions 23 of the elastic arms 21 respectively so as to fasten the male fastener 2 and the female fastener 1 together. Additionally, the body 10 further defines a restraining portion 105 which extends horizontally from a bottom of the body 10 and connects with the insertion opening 103. As shown in FIG. 2, the strap 3 is pressed by the restraining portion 105 of the body 10 when the male fastener 2 and the female fastener 1 are engaged.

The operating member 12 includes a frame 15, a top 16 and a bottom 14. The frame 15 is sandwiched between the top 16 and the bottom 14. The frame 15 has two edges each formed with two resilient hooks 152 and a stop portion 151. The frame 15 is disposed in the lower room 107 of the main room 101 with the two resilient hooks 152 correspondingly trapped in two side lateral slots which are defined in a side wall of the lower room 107 such that two resilient hooks 152 is slidable along the lateral slots. In such a manner, the frame 15 can be pushed to move within the lower room 107 on condition that the frame 15 is allowed to move, and thereby the operating member 12 is movable upon the female fastener 1. The top 16 has an aperture 160 and a window 162. The size of the top 16 is a little larger than that of the frame 15 and is a little smaller than that of the upper room 106 of the main room 101. The top 16 is formed on a top of the frame 15 and is disposed in the upper room 106 of the main room 101. When the frame 15 moves in the lower room 107, the top 16 follows the frame 15 and moves in the upper room 106 simultaneously.

The key locking mechanism 4 includes a cylinder 41, a core shaft 42, a block 43, a channel 44 and a positioning part 45. The cylinder 41 has a top connected to the top 16 of the operating member 12 and with its outlet 410 aligned with the aperture 160 of the top 16. The core shaft 42 is rotatably disposed in the cylinder 41. The core shaft 42 has one end received in the aperture 160 of the top 16 with its key hole 420 exposed on a surface of the top 16, and the other end received in an aperture 140 of the bottom 14 such that the core shaft 42 is firmly positioned between the top 16 and the bottom 14 of the operating member 12. The block 43 and the channel 44 extend from edges of the core shaft 42. As illustrated above, the key locking mechanism 4 is sandwiched between the top 16 and the bottom 14 of the operating member 12.

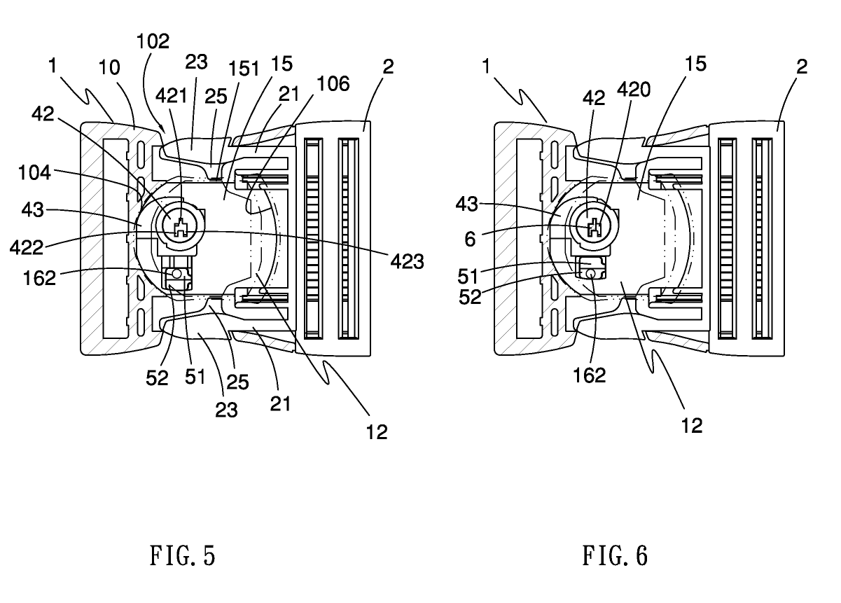

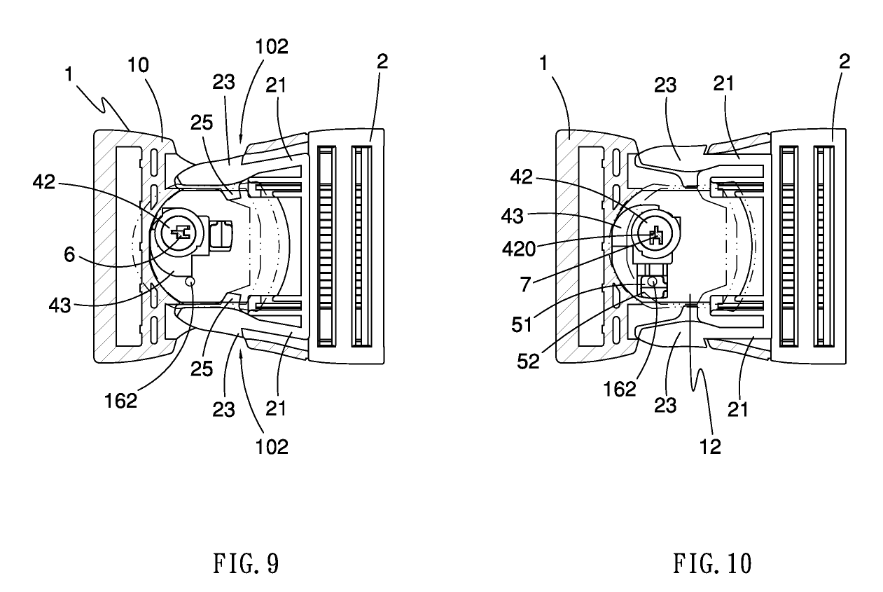

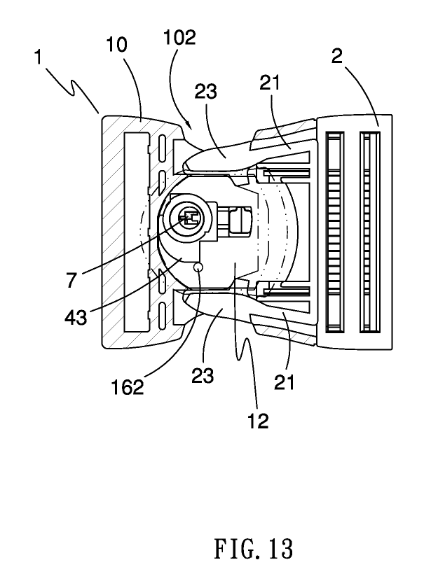

As noted above, the operating member 12 including the frame 15, the top 16 and the bottom 16 as a whole is movable to a first position and a second position within the main room 101 of the body 10. As shown in FIG. 5, when the operating member 12 is in the first position, the inward protrusions 25 of the two elastic arms 21 of the male fastener 2 are blocked by the stop portions 151 of the frame 15 of the operating member 12, referring also to FIG. 1, such that the two elastic arms 21 are not allowed to be pressed inwardly. In this state, the outward protrusions 23 of the elastic arms 21 are confined in the side openings 102. Contrarily, as illustrated in FIGS. 8 or 12, the stop portions 151 block the inward protrusions 25 no more when the operating member 12 is pushed to the second position. In this state, as shown in FIGS. 9 or 13, the elastic arms 21 can be inwardly pressed to allow the outward protrusions 23 being released from the two side openings 102 of the body 10.

It is to be noted that the key locking mechanism 4 is disposed on the operating member 12 and moves together with the operating member 12 simultaneously. However, the key locking mechanism 4 controls whether the operating member 12 is allowed to move, as will be set forth later.

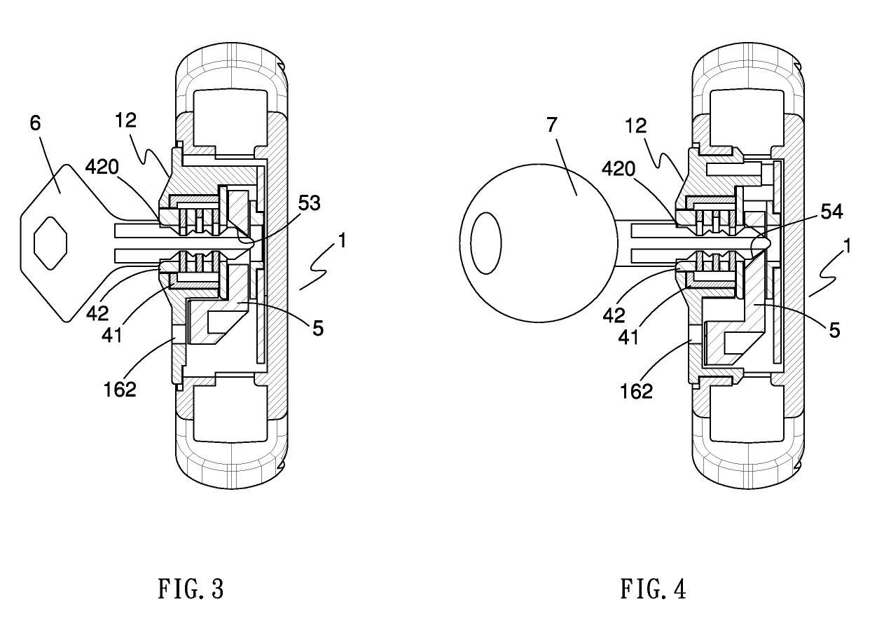

Referring to FIGS. 5, 3 and 4, the key hole 420 of the core shaft 42 includes a first slot 421, a second slot 422 and a third slot 423. The first and the second slots 421, 422 are in communication with each other to receive a first key 6. The first and the third slots 421, 423 are in communication with each other to receive a second key 7. The core shaft 42 can be driven by either the first key 6 or the second key 7 to lock the male fastener 2 in the female fastener 1 or release the male fastener 2 from the female fastener 1.

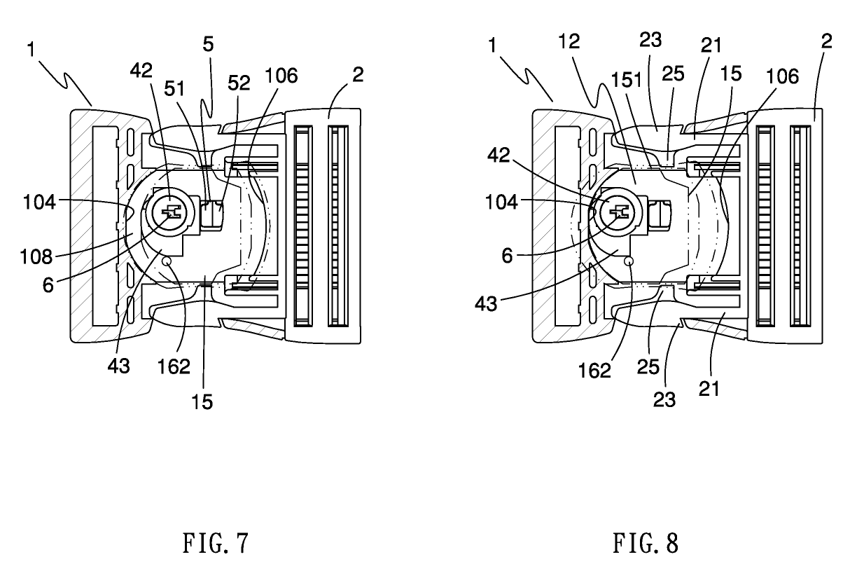

Referring back to FIGS. 1 and 2, the indicator 5 is disposed in the main room 101 of the body 10 of the female fastener 1 and has an end received in the channel 44 of the key locking mechanism 4. The indicator 5 is movable to a first displaying position and a second displaying position within the channel 44 and temporarily secured on the positioning part 45 of the key locking mechanism 4. On the other side, since the indicator 5 is disposed on the key locking mechanism 4, the indicator 5 rotates with and about the core shaft 42 to a third displaying position when the core shaft 42 rotates, as illustrated in FIG. 7. The indicator 5 has a first identification area 51, a second identification area 52, a first ramp 53, a second ramp 54 and a recess 55. The first and the second identification areas 51, 52 are correspondingly to the window 162 of the top 16 of the operating member 12. The first and the second ramps 53, 54 are respectively disposed in diagonal corners of the recess 55 and both face to the key hole 420 of the core shaft 42. Referring to FIG. 3, when the first key 6 is inserted into the key hole 420 of the core shaft 42, the first key 6 pushes the first ramp 53 to move the indicator 5, in a direction toward the core shaft 42, from the first displaying position where the first identification area 51 is visible through the window 162, as depicted in FIG. 5, to the second displaying position where the second identification area 52 instead of the first identification area 51 is displayed in the window 162, as depicted in FIG. 6. Thus, a user can identify whether the strap lock has been inserted by the first key 6 via the indicator 5 displayed in the window 162. Contrarily, referring to FIG. 4, when the second key 7 is inserted into the key hole 420 of the core shaft 42, the second key 7 pushes the second ramp 54 to move the indicator 5 from the second displaying position, as depicted in FIG. 6, back to the first displaying position, as depicted in FIG. 10. In this state, the second identification area 52 is no longer displayed in the window 162 but the first identification area 51 instead. Accordingly, the user can use the second key 7 to restore the indicator 5 back to its original position, namely the first displaying position, without need of other inserts. In addition, no matter if the core shaft 42 is driven by the first key 6 or the second key 7, when the indicator 5 moves to the third displaying position or a fourth displaying position, the first and the second identification areas 51, 52 of the indicator 5 are both vanished from the window 162.

In addition, the block 43 of the key locking mechanism 4 can be driven by the core shaft 42 to move to a blocking position and a releasing position. As depicted in FIG. 5, when the block 43 is in the blocking position, the block 43 abuts against a side wall 104 of the main room 101 so as to confine the operating member 12 in the first position. Referring to FIG. 6, when the keyhole 420 of the core shaft 42 is inserted by the first key 6, the block 43 keeps still. However, referring to FIG. 7, when the core shaft 42 is driven by the first key 6 to rotate, the block 43 moves to the releasing position without abutting the side wall 104, which creates a space 108 in the main room 101 for the operating member 12 moving toward the second displaying position, as depicted in FIG. 8.

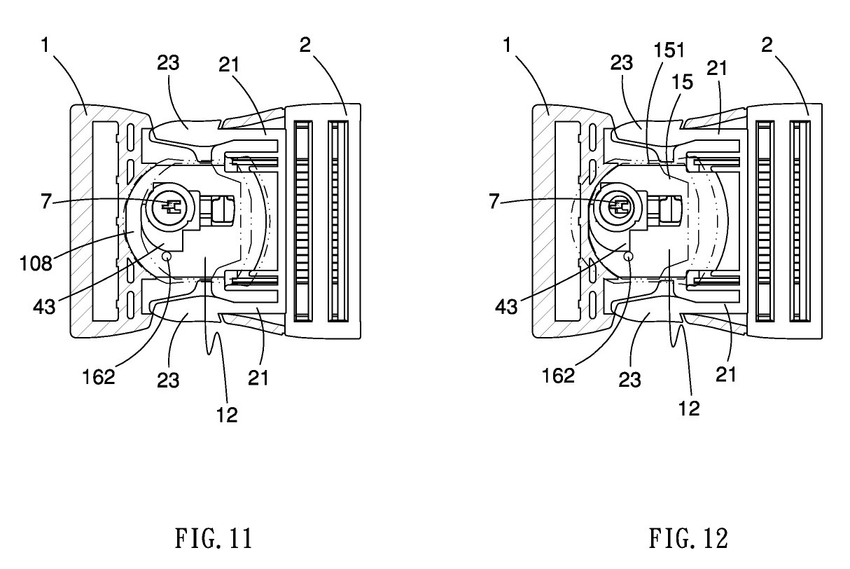

From the foregoing embodiment, the key hole 420 of the core shaft 42 of the key locking mechanism 4 of the strap lock according to the present invention can be inserted by the first key 6, as shown in FIG. 6, to enable the indicator 5 to move from the first displaying position to the second displaying position. In addition, the core shaft 42 can further be driven by the first key 6 to rotate, as shown in FIG. 7, to drive the block 43 to the releasing position so as to allow the operating member 12 being pushed to the second position, as shown in FIG. 8. When the operating member 12 is in the second position, the two elastic arms 21 of the male fastener 2 can be inwardly pressed, as shown in FIG. 9, to be released from the side openings 102 of the female fastener 1. Similarly, the key hole 420 can also be inserted by the second key 7, as shown in FIG. 10, to enable the indicator 5 to move from the second displaying position back to the first displaying position. The core shaft 42 can be driven by the second key 7 to rotate, as shown in FIG. 11, to drive the block 43 to the releasing position so as to allow the operating member 12 being pushed to the second position, as shown in FIG. 12. When the operating member 12 is in the second position, the two elastic arms 21 of the male fastener 2 can be inwardly pressed, as shown in FIG. 13, to be released from the side openings 102 of the female fastener 1.

Numerous characteristics and advantages of the invention have been set forth in the foregoing description. The disclosure, however, is illustrative only, and changes may be made in detail within the principle of the invention, to the full extent indicated by the broad general meaning of the terms in which the appended claims are expressed.

1. A buckle lock comprising:
a male fastener including two elastic arms each having an outward protrusion;
a female fastener defining an insertion opening and two side openings in communication with the insertion opening; the insertion opening provided for being inserted by the two elastic arms of the male fastener; the two side openings provided for receiving the outward protrusions of the elastic arms respectively so as to fasten the male fastener and the female fastener;
a key locking mechanism disposed on the female fastener and capable of locking the male and the female fasteners together or releasing the male fastener from the female fastener; and
an indicator movably disposed on the female fastener and moving from a first displaying position to a second displaying position when the key locking mechanism is operated.

2. The buckle lock of claim 1 wherein the key locking mechanism includes a core shaft defining a key hole for receiving a first key; the core shaft can be driven by the first key to lock the male and the female fasteners together or release the male fastener from the female fastener; and the indicator moves from the first displaying position to the second displaying position when the first key is inserted into the key hole.

3. The buckle lock of claim 2 wherein the key hole of the core shaft is capable of receiving a second key; the core shaft can be driven by the second key; and the indicator moves from the second displaying position to the first displaying position when the second key is inserted into the key hole.

4. The buckle lock of claim 3 wherein the key locking mechanism includes a cylinder; the core shaft is rotatably disposed in the cylinder; and the key hole includes a first slot, a second slot and a third slot; the first and the second slots being in communication with each other to receive the first key; and the first and the third slots being in communication with each other to receive the second key.

5. The buckle lock of claim 4 wherein the indicator has a first ramp facing the key hole; and when the first key is inserted into the key hole, the first key pushes the first ramp to move the indicator from the first displaying position to the second displaying position.

6. The buckle lock of claim 5 wherein the indicator further has a second ramp facing the key hole; and when the second key is inserted into the key hole, the second key pushes the second ramp to move the indicator from the second displaying position to the first displaying position.

7. The buckle lock of claim 2 wherein the female fastener includes a body and an operating member movably disposed on the body and the key locking mechanism controls whether the operating member is allowed to move to a first position where the outward protrusions of the two elastic arms are caught in the two side openings, and a second position where the outward protrusions of the two elastic arms are allowed to be released from the two side openings.

8. The buckle lock of claim 7 wherein the key locking mechanism is disposed in the operating member and includes a block; the block capable of being driven by the core shaft to move to a blocking position where the operating member is confined in the first position, and a releasing position where the operating member is allowed to move from the first position to the second position.

9. The buckle lock of claim 8 wherein the indicator is disposed on the key locking mechanism and moves to a third displaying upon rotation of the core shaft.

10. A strap lock comprising:
a strap;
a male fastener connected to one end of the strap;
a female fastener connected to the other end of the strap and detachably connected to the male fastener; and
a key locking mechanism disposed on the female fastener and including a core shaft having a key hole which is capable of receiving either one of a first key and a second key; wherein the core shaft can be driven by either one of the first key and the second key to lock or release the male fastener.

11. The strap lock of claim 10 wherein the key locking mechanism includes a cylinder; the core shaft is rotatably disposed in the cylinder; and the key hole includes a first slot, a second slot and a third slot; the first and the second slots being in communication with each other to receive the first key; and the first and the third slots being in communication with each other to receive the second key.

12. The strap lock of claim 11 further comprising an indicator movably disposed on the female fastener and moving from a first displaying position to a second displaying position when the first key is inserted into the key hole.

13. The strap lock of claim 12 wherein the indicator moves from the second displaying position to the first displaying position when the second key is inserted into the key hole.

14. The strap lock of claim 13 wherein the indicator has a first ramp facing the key hole; and when the first key is inserted into the key hole, the first key pushes the first ramp to move the indicator from the first displaying position to the second displaying position.

15. The strap lock of claim 14 wherein the indicator further has a second ramp facing the key hole; and when the second key is inserted into the key hole, the second key pushes the second ramp to move the indicator from the second displaying position to the first displaying position.

16. The strap lock of claim 10 wherein the female fastener includes a body and an operating member movably disposed on the body and the key locking mechanism controls whether the operating member is allowed to move to a first position where the male fastener is locked in the female fastener, and a second position where the male fastener is allowed to be released from the female fastener.

17. The strap lock of claim 16 wherein the key locking mechanism is disposed in the operating member and includes a block; the block capable of being driven by the core shaft to move to a blocking position where the operating member is confined in the first position, and a releasing position where the operating member is allowed to move from the first position to the second position.

18. The strap lock of claim 17 further comprising an indicator movably disposed on the female fastener and moving from a first displaying position to a second displaying position when the first key is inserted into the key hole.

19. The strap lock of claim 18 wherein the indicator moves from the second displaying position to the first displaying position when the second key is inserted into the key hole.

20. The strap lock of claim 18 wherein the indicator is disposed on the key locking mechanism and moves to a third displaying upon rotation of the core shaft.
